(19) United States
(12) Patent Application Publication
(10) Pub. No.: US 2003/0046592 A1
(43) Pub. Date: Mar. 6, 2003

(54) Personal video recorder with secure recording, storage and playback control

(76) Inventor: Wayne D. Woodruff, Chalfont, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/941,033

(22) Filed: Aug. 28, 2001

(51) Int. Cl. H04L 9/32

(52) U.S. Cl. 713/202

(57) ABSTRACT

Personal Video Recorders permit a user to digitally record Multi-media programming for subsequent replay by a user. The present invention comprises a PVR device that has the added facility of secure recording, and playback mechanisms that operate in response to the input of at least one unique user authorization instruction, thereby preventing minors or other unauthorized users from the unauthorized recording, storage and playback of Multi-media programs.

### FIELD OF THE INVENTION

The present invention pertains to the field of Digital Recording, and to Personal Video Recorders in particular

### BACKGROUND OF THE INVENTION

Personal Video Recorders (PVR's) are gaining increased popularity in the homes of users seeking an alternative to video recorders utilizing tape cartridges of various formats such as VHS for storage of recorded video. With the advent of digital video technology and the advances in the storage of data, several manufacturers of electronic consumer devices are now offering devices that allow a user to record digital video on to a hard disk, for example, for playback at the user's convenience.

Typically, PVR's incorporate features that allow a user to program, in advance, the desired television program to be recorded. Parameters typically utilized in the programming of PVR's include program time, channel number, program date and program name, for example. Once recorded, recorded programs are retrieved from the storage component of the PVR for viewing by the user during playback.

Currently, available PVR's possess some drawbacks in that they do not make provision for secure controls that prevent the unauthorized recording and playback of television programming. As a result, minors, for example, can readily record adult television material that is unauthorized by their parents, and playback such programs as long as they are capable of programming the PVR to record specific television programs.

Currently available set top boxes, for example, permit a user to control the selection of channels to tune to. However, no such provision is made for recording of specific channels. Thus a minor, for example, could circumvent parental controls geared towards controlling channels that can be viewed via a set top box by recording the restricted channels with a conventional PVR, and later viewing the recorded restricted material.

### SUMMARY OF THE INVENTION

These and other problems are addressed by the present invention. In particular, the present invention provides programming and playback features that require authorization by an authorized user prior to recording and playback of video programs.

According to one aspect of the present invention, a method for the secure recording and playback of Multi-media programming by a recording device comprises inputting a recording authorization instruction into a recording device, the authorization instruction operating to authorize activation of a recording mechanism component of the recording device; selecting at least one Multi-media program to be recorded; recording the Multi-media program; storing the Multi-media program in a storage component of the recording device; inputting a playback authorization instruction into the recording device, the playback authorization instruction operative to authorize the activation of a playback mechanism component of the recording device; and playing back the Multi-media program.

According to another aspect of the present invention, in the above method, the recording authorization instruction and the playback authorization instruction are identical.

According to another aspect of the present invention, in the above method, the recording authorization instruction comprises a first security access code.

According to another aspect of the present invention, in the above method, the recording authorization instruction comprises a first security access code.

According to another aspect of the present invention, in the above method, the first security access code comprises a first password.

According to another aspect of the present invention, in the above method, the Multi-media program comprises one of Cable broadcasts, Satellite broadcasts and television programs broadcast in at least one of UHF, VHF, HDTV transmission formats.

According to another aspect of the present invention, in the above method, the storage component of said recording device is a hard disk.

According to another aspect of the present invention, in the above method, the playback authorization instruction comprises a second security access code.

According to another aspect of the present invention, in the above method, the second security access code is a password.

According to yet another aspect of the present invention, a method for the secure recording and playback of Multi-media programming by a recording device comprises:

designating specific Multi-media programs as restricted, the restricted Multi-media programs requiring at least one of a playback authorization instruction and a recording authorization instruction to authorize the recording device to either record or playback the restricted Multi-media programs; inputting the recording authorization instruction into the recording device, the recording authorization instruction operating to authorize activation of a recording mechanism component of the recording device; recording at least one of the restricted Multi-media programs; inputting a playback authorization instruction into the recording device, the playback authorization instruction operating to authorize activation of a playback mechanism component of said recording device; storing the Multi-media program in a storage component of the recording device; and playing back the restricted Multi-media programs.

According to another aspect of the present invention, in the above method, the recording authorization instruction and said playback authorization instruction are identical.

According to another aspect of the present invention, a device for the secure recording of Multi-media programs comprises:

a programmable recording device having 1) a recording mechanism and 2) a playback mechanism. The recording mechanism is adapted to record Multi-media programs and the playback mechanism is adapted to playback recorded Multi-media programs. The device also includes a programming control interface, operative to 1) activate the recording mechanism in response to a first user authorization instruction, and 2) activate the playback mechanism in response to a second user authorization instruction, wherein recording of the Multi-media programs requires the first user authorization instruction to be entered into the programming control interface thereby activating the recording mechanism and permitting the Multi-media programs to be recorded, and playback of the recorded Multi-media programs requires the second user authorization to be entered into the programming control interface thereby activating the playback mechanism and permitting the recorded Multi-media programs to be played.

According to another aspect of the present invention, in the above device, the programmable recording device is a Personal Video Recorder.

According to another aspect of the present invention, a device for the secure recording of Multi-media programs comprises: a programmable recording device, having 1) a recording mechanism and 2) a playback mechanism. The recording mechanism is adapted to record Multi-media programs and the playback mechanism is adapted to playback recorded Multi-media programs. The device also includes a programming control interface that operates to designate or undesignate the Multi-media programs as restricted or unrestricted at the option of the user and in response to a first user authorization instruction.

The programmable control interface also operates to selectively activate the recording mechanism in response to a second user authorization instruction, and also selectively activate or selectively deactivate the playback mechanism in response to a third user authorization instruction, wherein designating or undesignating the Multi-media programs as restricted and unrestricted requires the first user instruction to be entered into the programming control interface. Furthermore, recording the restricted and unrestricted Multi-media programs requires the second user authorization instruction to be entered into the programming control interface thereby activating the recording mechanism and permitting the restricted and unrestricted Multi-media programs to be recorded. Playback of the recorded restricted or unrestricted Multi-media programs requires the third user authorization instruction to be entered into the programming control interface thereby activating the playback mechanism and permitting at least one of the recorded restricted or unrestricted Multi-media programs to be played.

According to yet another aspect of the present invention, an arrangement for the secure recording and playback of Multi-media programs comprises: a programmable recording and playback device adapted to selectively record and playback Multi-media programs in response to at least one unique user authorization instruction; a Multi-media programming source operatively connected to the recording and playback device and adapted to play Multi-media programs transmitted from at least one of a remote and local source; and a display device, operatively connected to at least one of the recording and playback device and the Multi-media programming source wherein, in response to the unique user authorization instruction, the programmable recording and playback device selectively 1) authorizes a recording of at least one of the Multi-media programs, 2) records the Multi-media programs, 3) plays back the Multi-media programs and 4) selectively displays the Multi-media programs on the display device.

According to another aspect of the present invention, in the above arrangement, the Multi-media programming source comprises one of a cable set top box, satellite receiver and television receiver.

According to another aspect of the present invention, in the above arrangement, the Multi-media programming source comprises one of a cable set top box, satellite receiver and television receiver.

According to another aspect of the present invention, in the above arrangement, the unique user authorization comprises one of a recording authorization instruction and a playback authorization instruction.

### BRIEF DESCRIPTION OF THE DRAWINGS

FIG. 1 depicts a schematic of a conventional PVR.

FIG. 2 depicts a schematic of a method in accordance with a first embodiment of the present invention.

FIG. 3 depicts a schematic of a PVR in accordance with a first embodiment of the present invention.

FIG. 4 depicts a schematic of a method in accordance with a second embodiment of the present invention.

FIG. 5 depicts a schematic of a device in accordance with a second embodiment of the present invention.

FIG. 6 depicts an arrangement in accordance with the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not all necessarily referring to the same embodiment.

The embodiments of the invention include inter alia a method and apparatus for the secure recording and playback of television programs.

PVRs are quickly becoming the device of choice for the recording of Multi-media including Cable, Satellite transmissions and Broadcast television. While PVRs are prevalent as discrete stand-alone devices that can be coupled with other devices such as TVs, video recorders, game players and the like, they can also be incorporated in a digital television, cable set top box or in a Personal Computer (PC).

Conventional PVRs permit Multi-media programs to be recorded and replayed with a series of simple programming steps. A conventional PVR is depicted in FIG. 1 and as depicted therein, a conventional PVR 100 includes a recording mechanism 101 and playback mechanism 102. A storage component (not shown) is usually integrated in the PVR to provide storage for recorded material.

At a user's command, either contemporaneous with, or in advance of the playing of material to be recorded, the PVR 100 records, and stores the recorded program for later viewing and playback via simple commands directed to playback mechanism 102. PVR 100 typically incorporates programming functions such as date of program to be recorded, time of program to be recorded as well as channel from which to record, for example. However, distinctions between what is authorized to be recorded, and what is unauthorized exceeds the programming capability of currently available PVRs.

The methods of the present invention incorporate a functionality by which the programming of a PVR to record and playback Multi-media programs is secured by requiring the input of unique user authorization instructions to enable recording and playback thereby preventing unauthorized programs from being recorded and subsequently played back.

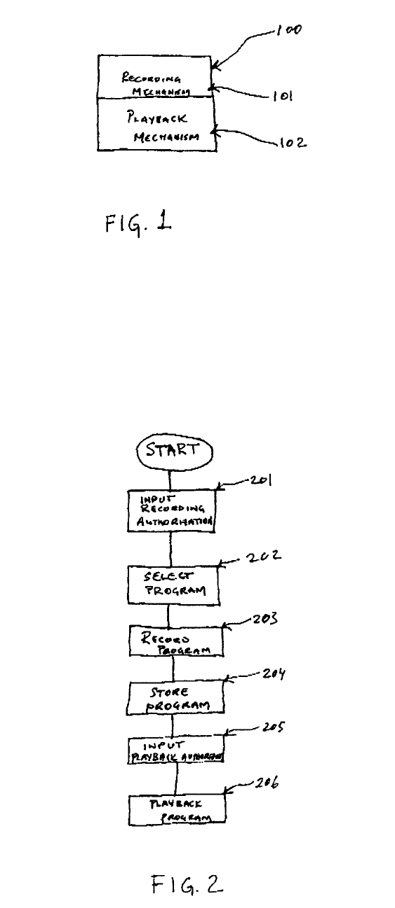

Turning now to FIG. 2, the method of a first embodiment of the present invention is depicted therein. As is depicted by step 201, prior to recording a Multi-media program on a PVR in accordance with the present invention requires, at the option of the owner or authorized user of the unit, that a recording authorization instruction be entered. This instruction could be a password or access code, for example, which serves to authorize the recording mechanism of a PVR in accordance with the present invention to accept user instructions to record one or more Multi-media programs. Once the recording authorization depicted in step 201 is accepted, the user can then select the Multi-media programs to be recorded in conventional fashion as depicted in step 202. Once selected, the Multi-media programs are recorded conventionally as depicted in step 203. Recorded programs are then conventionally stored as depicted in step 204.

Subsequent playback of recorded programs then requires that a playback authorization instruction be input into the PVR as depicted by step 205. Similar to the recording authorization instruction of step 201, the playback authorization step 205 authorizes the playback mechanism of a PVR in accordance with the present invention to accept user instructions relative to the playback of stored, recorded material. Here again, the playback authorization instruction of step 205 can be a password or access code as determined by the owner of the PVR. Once the playback authorization is accepted, playback of the recorded material can proceed in conventional fashion.

It should be noted that the requirements for the inputting of a recording authorization instruction as depicted in step 201, and the inputting of a playback authorization instruction as depicted in step 205, can be overridden by the PVR owner or authorized user equipped with the requisite authorization instructions. This feature permits a PVR in accordance with the present invention to function conventionally, i.e. without the need for authorization instructions for recording or playback. Moreover, while the recording authorization instruction and playback authorization instruction may be unique to one another, they can be made identical, at the option of the owner or authorized user. Thus it is entirely possible for a PVR in accordance with the present invention to be configured and programmed such that the recording and playback authorization instructions comprise identical access codes or passwords, for example.

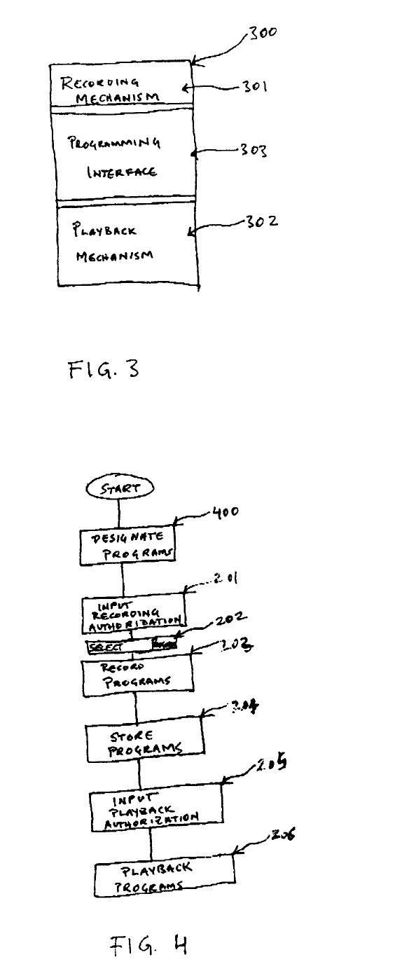

A PVR device in accordance with the present invention is depicted in FIG. 3. As is depicted therein, a PVR 300 in accordance with the present invention includes a recording mechanism 301, and a playback mechanism 302. The PVR 300 also includes a Programming interface 303, which controls the programming of the operation of recording mechanism 300 and playback mechanism 302. As outlined with respect to the method of FIG. 2, operation of recording mechanism 301 and playback mechanism 302, respectively require the input of user authorization instructions into programming interface 303.

Thus, to initiate a recording by PVR 300, a recording authorization instruction is entered into programming interface 303. Once entered and accepted, the recording authorization instruction enables recording functions to be initiated in conventional fashion. By the same token, to initiate playback, a playback authorization code is required to be entered into programming interface 303 to authorize playback functions to be performed in conventional fashion.

Turning now to FIG. 4, a method in accordance with a second embodiment of the present invention is presented. As depicted in FIG. 4, the operation of a PVR in accordance with the embodiment depicted in FIG. 4 has the added functionality of being able to selectively designate Multi-media programs as restricted or unrestricted upon entry of a first user authorization instruction. This functionality is depicted in step 400 of FIG. 4. Thus, in operation, an authorized user equipped with the requisite first user authorization instruction can program the PVR in accordance with the method of FIG. 4, and step 400 in particular, to block recording of Multi-media programs designated as restricted, and permit the recording of programs designated as unrestricted. Once programs are so designated, all other functionalities shown in FIG. 4 are identical to that described in conjunction with the method outlined in FIG. 2, and defined by steps 201 thru 206 of FIGS. 2 and 4 respectively. In this instance however, the, additional user authorization instructions depicted in steps 201 and 205 are required only to authorize recording and playback of Multi-media programs designated as restricted. Thus, once step 400 is complete, a PVR in accordance with FIG. 4 will operate as a conventional unit for recording and playing back unrestricted programs and the recording user authorization and playback user authorization outlined with respect to FIG. 2 are required for the recording and playback of restricted material only.

FIG. 5 depicts a PVR device in accordance with the method of FIG. 4. As depicted therein, programming interface 503 with the added functionality to designate Multi-media programs as restricted or unrestricted is operatively connected to recording mechanism 501, and playback mechanism 502. In operation, a first user authorization code is entered to permit the selective designation of Multi-media programs as either restricted or unrestricted. A recording authorization instruction is then subsequently entered only to permit recording and storage of Multi-media programs designated as restricted, in accordance with the method outlined with respect to FIG. 4. Programs designated as unrestricted can thus be recorded and played back in conventional fashion without the need for an authorization instruction for the respective recording and playback steps.

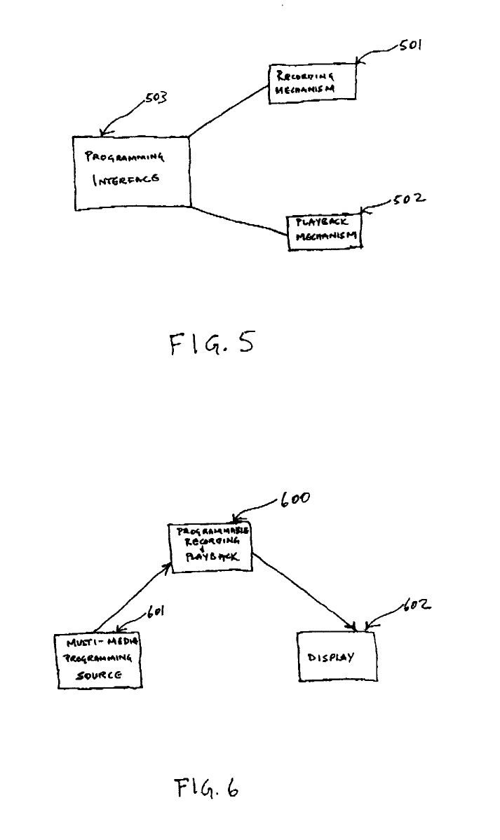

FIG. 6 depicts an arrangement in accordance with the methods and apparatus of the present invention. As depicted therein, PVR 600 is operatively connected to a Multi-media programming source 601 such as a cable set top box, satellite receiver, television receiver or the like. The PVR 600 has the functionality described by the methods of FIG. 2 and FIG. 4 respectively wherein the secure recording and playback of Multi-media programs is achieved.

All the features disclosed in this specification (including any accompanying claims, abstract and drawings), and/or all of the steps or any method or process so disclosed, may be combined in any combination, except combinations where at least some of the features and or steps are mutually exclusive. Each feature disclosed in this specification (including any accompanying claims, abstract and drawings) may be replaced by alternative features serving the same equivalent or similar purpose, unless expressly stated otherwise. Thus unless expressly stated otherwise, each feature disclosed is one example only of a generic series of equivalent or similar features. Moreover, although various embodiments are specifically illustrated and described herein, it will be appreciated that modifications and variations of the invention are covered by the above teachings and within the purview of the appended claims without departing from the spirit and intended scope of the invention.

What is claimed is:

1. A method for the secure recording and playback of Multi-media programming by a recording device comprising:
inputting a recording authorization instruction into a recording device, said authorization instruction operating to authorize activation of a recording mechanism component of said recording device;
recording said at least one Multi-media program;
inputting a playback authorization instruction into said recording device, said playback authorization instruction operative to authorize the activation of a playback mechanism component of said recording device; and
playing back said at least one Multi-media program.

2. The method according to claim 1 wherein said recording authorization instruction and said playback authorization instruction are identical.

3. The method according to claim 1 wherein said recording authorization instruction comprises a first password.

4. The method according to claim 1 wherein said at least one Multi-media program comprises one of Cable broadcasts, Satellite broadcasts and television programs broadcast in at least one of UHF, VHF, HDTV transmission formats.

5. The method according to claim 1 wherein said recording device includes a storage component comprising a hard disk.

6. The method according to claim 1 wherein said playback authorization instruction comprises a second password.

7. The method according to claim 1 further including a step of designating a specific Multi-media program as restricted.

8. The method according to claim 7 further including a step of playing back said restricted Multi-media program upon receipt of said playback authorization instruction.

9. A method for the secure recording and playback of Multi-media programming by a recording and playback device comprising:
designating specific Multi-media programs as restricted, said restricted Multi-media programs requiring at least one of a playback authorization instruction and a recording authorization instruction to authorize said recording device to one of record and playback said restricted Multi-media programs;
inputting said recording authorization instruction into said recording device, said recording authorization instruction operative to authorize activation of a recording mechanism component of said recording device;
recording at least one of said restricted Multi-media programs; and
inputting a playback authorization instruction into said recording device, said playback authorization instruction operative to authorize activation of a playback mechanism component of said recording device.

10. The method according to claim 9 wherein said recording authorization instruction and said playback authorization instruction are identical.

11. The method according to claim 9 wherein said recording authorization instruction comprises a first password.

12. The method according to claim 9 wherein said playback authorization instruction comprises a second password.

13. A device for the secure recording of Multi-media programs comprising:
a programmable recording device, said recording device having 1) a recording mechanism and 2) a playback mechanism, said recording mechanism adapted to record Multi-media programs, said playback mechanism adapted to playback recorded Multi-media programs; and
a programming control interface, said programming control interface operative to selectively 1) activate said recording mechanism in response to a first user authorization instruction, and 2) selectively activate said playback mechanism in response to a second user authorization instruction, wherein 1) recording of said Multi-media programs requires said first user authorization instruction to be entered into said programming control interface thereby activating said recording mechanism and permitting said Multi-media programs to be recorded, and 2) playback of said recorded Multi-media programs requires said second user authorization to be entered into said programming control interface thereby activating said playback mechanism and permitting said recorded Multi-media programs to be played.

14. The device according to claim 13 wherein said Multi-media programs comprise one of Cable broadcasts, Satellite broadcasts and television programs broadcast in at least one of UHF, VHF and HDTV transmission formats.

15. The device according to claim 13 wherein said first user authorization instruction and second user authorization instruction are identical.

16. The device according to claim 13 wherein said recording authorization instruction comprises a first password.

17. The device according to claim 13 wherein said playback authorization instruction comprises a second password.

18. The device according to claim 13 further including an interface for receiving Multi-media programs selectively designated as restricted.

19. The device according to claim 18 wherein said device is arranged to playback said restricted Multi-media program upon receipt of said playback authorization instruction.

20. A method for the secure recording and playback of Multi-media programming by a recording and playback device comprising:
designating specific Multi-media programs as restricted;
inputting a playback authorization instruction into said recording device, said playback authorization instruction operative to authorize activation of a playback mechanism component of said recording device; and
playing back said restricted Multi-media programs.

21. The method according to claim 20 wherein said first user authorization instruction and second user authorization instruction are identical.

22. The method according to claim 20 wherein said recording authorization instruction comprises a first password.

23. The method according to claim 20 wherein said playback authorization instruction comprises a second password.

24. A programming control interface for use with a recording device having a recording mechanism and a playback mechanism, comprising:
1) a recording activator for activating said recording mechanism in response to a first user authorization instruction, and
2) a playback activator for selectively activating said playback mechanism in response to a second user authorization instruction,
wherein 1) the programming control interface is adapted such that the recording of said Multi-media programs requires said first user authorization instruction to be entered into said programming control interface thereby activating said recording mechanism and permitting said Multi-media programs to be recorded, and 2) playback of a recorded Multi-media program requires said second user authorization instruction to be entered into said programming control interface thereby activating said playback mechanism and permitting said recorded Multi-media programs to be played.
